(19) United States
(12) Patent Application Publication
(10) Pub. No.: US 2008/0086399 A1
(43) Pub. Date: Apr. 10, 2008

(54) Auto credit scanner pre-approval process

(76) Inventor: Charles Wood, St. Clair Shores, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/528,864

(22) Filed: Sep. 28, 2006

(51) Int. Cl. G06Q 40/00

(52) U.S. Cl. 705/35

(57) ABSTRACT

The present invention includes an automated credit approval process that provides a pre-approval package based upon information gathered from a basic form of customer identification. A potential customer provides a basic form of personal information, such as a driver's license, to a vendor. The basic personal information is scanned into a data management system where it is subsequently transferred to a credit reporting agency through an automated credit server. The automated credit approval server includes a decisioning platform that compares at least one of a plurality of credit attributes contained within a credit file received from the credit reporting agency with a pre-determined set of creditworthiness criteria established by various lending institutions to generate a credit decision. This method of credit evaluation is conducted with only the basic information found on the driver's license and, as such, limits exposure of the potential customer's sensitive personal information, for example, their social security number and/or signature.

### BACKGROUND OF THE INVENTION

The present invention relates generally to a method of credit evaluation, and more particularly, to an automated credit approval process that provides a pre-approval package based upon information gathered from a basic form of customer identification.

Known methods of credit evaluation typically require a potential customer to fill out a paper credit application. Typically, a credit application requires the potential customer to provide sensitive customer identification information such as the customer's social security number and/or date of birth. This sensitive customer information is inputted into a computer system where it is transmitted to various credit reporting agencies for a credit evaluation. Based on the sensitive customer information, the credit reporting agencies generate a credit report and associated credit score, which are subsequently transmitted back to a requesting vendor. The vendor manually compares the credit information received from the various credit reporting agencies with lending criteria established by various lending institutions to determine what potential financing options are available for the potential customer and what the potential financing options are. The vendor subsequently informs the potential customer of any potential financing options available.

These known methods of credit evaluation may subject the potential customer to an increased risk of identity theft as the paper credit applications including the customer's sensitive identification information can be easily misplaced and are not always properly disposed of. In addition, these known methods are manually intensive. In the automotive sales field, the paper credit application is typically not filled out until after the potential customer has test driven at least one vehicle, these known methods of credit evaluation can be a waste of time for both the potential customer and the vendor. As an example, the potential customer may not be able to comfortably afford or even qualify for financing with respect to the vehicle he is interested in.

Therefore, it is desirable to provide an automated credit evaluation process that provides a pre-approval based on information gathered from a basic form of customer identification, such as a driver's license or state issued identification card, which does not subject a potential customer to an increased risk of identity theft, as opposed to a sensitive form of customer identification, such as a social security card.

### SUMMARY OF THE INVENTION

The present invention relates to a method of credit evaluation, and more particularly, to an automated credit approval process that provides a pre-approval package based upon information gathered from a basic form of customer identification.

A potential customer provides a basic form of personal information, such as a driver's license, to an automotive sales associate at an automotive dealership prior to a vehicle test drive.

The automotive sales associate scans the basic personal information contained on the driver's license into a data management system. The basic personal information is transferred to a credit reporting agency through an automated credit server via a secured method of data transfer in the form of an inquiry.

The credit reporting agency responds to the inquiry with a credit file associated with the potential customer. The automated credit approval server includes a decisioning platform that compares at least one of a plurality of credit attributes contained within the credit file with a pre-determined set of creditworthiness criteria established by various lending institutions.

Based upon the comparison, a credit decision is generated. The credit decision may be a pre-approval including a pre-approved amount and associated financing terms, e.g. terms and conditions of purchase and/or lease or a process complete, which indicates that the potential customer either has no credit or poor credit.

This method of credit evaluation is conducted with only the basic information found on the driver's license and, as such, limits exposure of the potential customer's sensitive personal information, for example, their social security number and/or signature.

These and other features of the present invention can be best understood from the following specification and drawings, the following of which is a brief description.

### BRIEF DESCRIPTION OF THE DRAWING

FIG. 1 is a schematic illustration of a method of automated credit evaluation according to one embodiment of the present invention.

### DETAILED DESCRIPTION OF THE PREFERRED EMBODIMENT

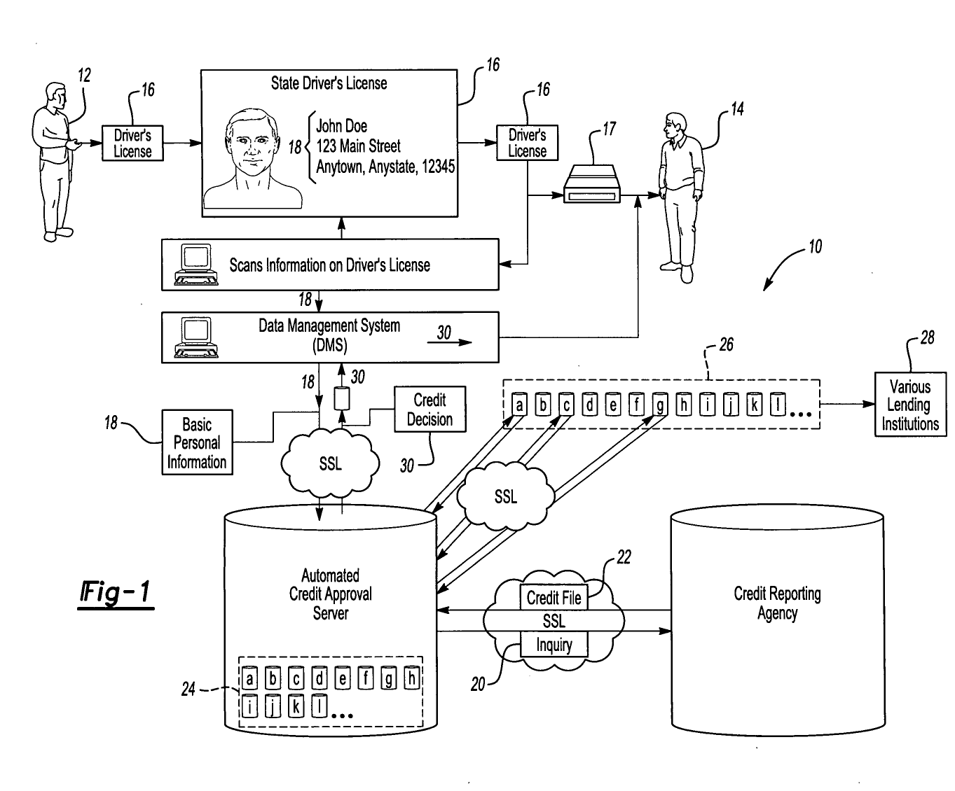

FIG. 1 is a schematic illustration of a method of automated credit evaluation 10 according to one embodiment of the present invention. In this example embodiment, a potential customer 12 comes into an automotive dealership to obtain a new vehicle. The potential customer 12 requests a test drive of a vehicle that he finds of interest. Prior to the test drive, however, an automotive sales associate 14 must obtain a copy of the potential customer's valid driver's license 16 to ensure that it is legal for the potential customer 12 to drive a vehicle, i.e. to comply with insurance requirements and/or to confirm an identity of the potential customer.

There are two primary types of credit inquiries that can be made: 1) a soft inquiry or 2) a hard inquiry. The soft inquiry is minimally invasive, as it requires only basic personal information 18 contained, for example, on a driver's license. The soft inquiry typically returns results granting or denying a pre-approval. If pre-approval is granted, a credit package detailing a credit offer, for example, amount and term conditions, will also be included. However, actual details associated with the potential customer's credit file are not released. Conversely, the hard inquiry is extremely invasive, as it requires additional sensitive personal information, such as the potential customer's social security number, date of birth, and/or signature. If pre-approval is denied, the potential customer may obtain further consideration by submitting the additional sensitive personal information. In a hard inquiry, the actual details of the potential customer's consumer credit file are released to the automotive sales associate.

Instead of making a traditional hard photocopy of the potential customer's driver's license 16, which can be easily misplaced, the automotive sales associate 14 makes the required copy of the potential customer's driver's license 16 by scanning the basic personal information 18 contained on the driver's license 16 into a data management system DMS. This allows the automotive sales associate 14 to conduct a soft inquiry, as discussed above, by utilizing a scanning device 17 that is typically already available within the automotive dealership and readily available to the automotive sales associate 14. For example, the scanning device 17 can be a bar code scanner that reads a bar code of a driver's license or an optical scanner that reads the basic information 18 from the driver's license using optical character recognition.

The scanned information is delivered to a credit reporting agency, for example, TransUnion. The scanned information is transferred from the data management system to the credit reporting agency through an automated credit approval server via a secure method of securing data, such as a secure socket layer SSL. The transfer generates an inquiry 20 at the credit reporting agency. In response to this inquiry 20, a credit file 22 is received by the automated credit approval server from the credit reporting agency, also through the secure method of securing data SSL.

The credit file 22 includes a plurality of credit attributes 24 (a, b, c, d, e, f, g, h, i, j, k, l, etc.), which may include but is not limited to whether the potential customer has an existing vehicle loan or lease, the amount of the most recent vehicle loan or lease, the term of an existing loan or lease, and whether the potential customer has a history of bankruptcy.

As an example, the plurality of credit attributes 24 may include any credit attribute indicative of a dollar amount associated with a previous vehicle purchase or lease. The absence of at least one credit attribute indicative of a dollar amount associated with a previous vehicle purchase or lease may trigger the automated credit approval server to generate a credit decision 30 including a pre-approval and a pre-set baseline firm offer. However, the existence of at least one credit attribute indicative of a dollar amount associated with a previous vehicle purchase or lease triggers the automated credit approval server to generate a credit decision 30 including a pre-approval and a firm offer based on the dollar amount associated with the previous vehicle purchase or lease.

The automated credit approval server includes a decisioning platform that evaluates the credit file by comparing at least one of the plurality of credit attributes 24 with a pre-determined set of creditworthiness criteria 26 (A, B, C, D, E, F, G, H, I, J, K, etc.) generated by various lending institutions 28. Based upon this comparison, a credit decision 30 is generated.

The credit decision 30 is delivered to the automotive sales associate 14 within a relatively short period of time, typically under a minute. The credit decision 30 can be delivered, for example, via an electronic message, such as an automated return message displayed on a computer sales screen, or an email. The credit decision 30 includes but is not limited to messages indicating that the potential customer is pre-approved or that the process is complete. If pre-approved, the message may also include a pre-approved amount and associated financing terms, e.g. term of purchase or lease, interest rate, etc. If process is complete, either the potential customer has no credit or questionable credit. If this is the case, the potential customer may opt for the more invasive hard inquiry discussed above.

It should be noted that the method of automated credit evaluation according to the present invention, is not limited to credit requests conducted by automotive dealerships. The inventive method can be utilized in any business transaction that requires a credit evaluation, which may include but is not limited to transactions such as, opening a merchant line of credit or obtaining a mortgage. Further, it should be noted that the form of identification need not be a driver's license, but may be any form of basic reliable personal identification, which may include but is not limited to a government issued identification card or a passport.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of automated credit evaluation comprising the steps of:
identifying a customer;
evaluating a creditworthiness of the customer based on the identification; and
generating a credit decision based on the creditworthiness of the customer, wherein evaluating the creditworthiness includes obtaining a plurality of credit attributes associated with at least one credit file.

2. The method of automated credit evaluation as recited in claim 1, wherein the step of identifying includes scanning an identification source associated with the customer to collect basic customer information.

3. The method of automated credit evaluation as recited in claim 2, further including the step of delivering the basic customer information to a data management system.

4. The method of automated credit evaluation as recited in claim 3, further including the step of transferring the basic customer information from the data management system to a credit reporting agency through an automated credit approval server.

5. The method of automated credit evaluation as recited in claim 4 wherein the at least one credit file is received by the automated credit approval server.

6. The method of automated credit evaluation as recited in claim 5, wherein the step of evaluating includes evaluating the credit file including the plurality of credit attributes and comparing at least one of the plurality of credit attributes with at least one criteria contained within a pre-determined set of creditworthiness criteria.

7. The method of automated credit evaluation as recited in claim 6, wherein the evaluation is conducted using a decisioning platform within an automated credit approval server.

8. The method of automated credit evaluation as recited in claim 6, wherein the plurality of credit attributes includes at least one dollar attribute, and an absence of the at least one dollar amount attribute results in the generation of a pre-set baseline firm offer.

9. The method of automated credit evaluation as recited in claim 6, wherein the plurality of credit attributes includes at least one dollar attribute, and an existence of the at least one dollar amount attribute results in the generation of a firm offer, wherein the firm offer is related to the at least one dollar amount attribute.

10. The method of automated credit evaluation as recited in claim 6, wherein the credit decision is generated based upon the comparison.

11. The method of automated credit evaluation as recited in claim 10, further including delivering the credit decision to the vendor.

12. The method of automated credit evaluation as recited in claim 11, wherein the credit decision includes a first message when the customer has questionable credit and a second message when the customer is creditworthy.

13. The method of automated credit evaluation as recited in claim 12, wherein when the first message is received, the vendor has an option of inputting additional customer information.

14. The method of automated credit evaluation as recited in claim 13, wherein the additional customer information is sensitive personal customer information.

15. The method of automated credit evaluation as recited in claim 12, wherein when the second message is received, the second message includes a credit package.

16. The method of automated credit evaluation as recited in claim 11, wherein the credit decision is delivered to the vendor via an automated return message displayed on a computer sales screen.

17. The method of automated credit evaluation as recited in claim 11, wherein the credit decision is delivered to the vendor via an electronic message.

18. The method of automated credit evaluation as recited in claim 1, wherein the creditworthiness is being evaluated for one of a purchase of a vehicle and a lease of a vehicle, and the customer is identified via information obtained from a driver's license.

19. The method of automated credit evaluation as recited in claim 18, wherein the information is obtained using a scanning device.

20. A method of automated credit evaluation comprising the steps of:
identifying a customer;
using the identity to obtain a plurality of credit attributes; and
making a credit decision based on the plurality of credit attributes.

21. The method of claim 20, wherein identifying comprises scanning an identification.

22. The method of claim 20, wherein identifying comprises a soft inquiry.

23. The method of claim 20, wherein at least one credit file includes the plurality of credit attributes.

24. The method of claim 20, wherein the plurality of credit attributes are from at least one credit reporting agency.

25. The method of claim 20 including varying the credit decision depending on the plurality of credit attributes.

26. The method of claim 20 including making the credit decision based on aggregating the plurality of credit attributes.
